(19) United States
(12) Patent Application Publication
(10) Pub. No.: US 2019/0319498 A1
(43) Pub. Date: Oct. 17, 2019

(54) STATOR AND MOTOR HAVING SAME

(71) Applicant: AMOTECH CO., LTD., Incheon (KR)

(72) Inventors: Byung Soo KIM, Anyang-si (KR); Hyung Hwan KO, Anseong-si (KR); Se Ki LEE, Incheon (KR)

(21) Appl. No.: 16/453,157

(22) Filed: Jun. 26, 2019

Related U.S. Application Data
(62) Division of application No. 15/453,143, filed on Mar. 8, 2017.
Application No. 15/453,143 is a division of application No. PCT/KR2015/009854, filed on Sep. 21, 2015.

(30) Foreign Application Priority Data
Sep. 23, 2014 (KR) 10-2014-0127043

(51) Int. Cl. H02K 1/08; H02K 16/02; H02K 1/14; H02K 1/02; H02K 16/00; H02K 1/27; H02K 7/116

(52) U.S. Cl. CPC H02K 1/08; H02K 16/02; H02K 1/148; H02K 7/116; H02K 16/005; H02K 1/2786; H02K 1/02

(57) ABSTRACT

Provided is a stator including: a plurality of stator cores; a bobbin wrapped around an outer circumferential surface of the stator core; and a coil wound around an outer circumferential surface of the bobbin, wherein each of the plurality of stator cores includes a first core portion that is formed by laminating a plurality of iron pieces, and around which a coil is wound, and a second core portion coupled to one end of the first core portion and disposed to face a magnet of a rotor and formed to be wider than an end surface area of the first core portion, and a motor having the same, to thus improve the efficiency of the motor.

### TECHNICAL FIELD

The present invention relates to a stator and a motor including the stator in which an area of a portion opposite to a stator core of a magnet is widely formed, thereby improving motor efficiency.

### BACKGROUND ART

Generally, an amorphous stator of a motor is comprised of a plurality of unit split core assemblies annularly assembled as disclosed in Korean Patent Registration Publication No. 10-1317892 (Oct. 27, 2013), wherein the plurality of unit split core assemblies include: a plurality of unit split cores that are each made by compressing and molding amorphous alloy powder in which both side ends of each of the unit split cores mutually contact each other to thus form an annular magnetic circuit; an insulating bobbin that is formed on an outer periphery of the plurality of unit split cores to thus define a coil forming region and assemble the plurality of unit split cores in an annular shape; and a coil wound around the insulating bobbin.

In such an amorphous stator, when the entire stator is made of an amorphous alloy powder, compression-molding is difficult and the efficiency of the motor is lowered.

### DISCLOSURE

### Technical Problem

An object of the present invention is to provide a stator and a motor having the stator in which a leakage magnetic flux is minimized by separately manufacturing a first core portion wound with a coil and a second core portion disposed opposite to a magnet, to then mutually bond the first core portion and the second core portion to each other, and enlarging an area of the second core portion compared to that of the first core portion, to thereby improve the efficiency of the motor.

Another object of the present invention is to provide a stator and a motor having the stator in which a second core portion disposed opposite to a magnet is formed by compression-molding amorphous metal powder, soft magnetic powder or a mixture of amorphous metal powder and soft magnetic powder, to thereby reduce a manufacturing cost and simplify a manufacturing process.

Still another object of the present invention is to provide a stator and a motor having the stator in which a first core portion and a second core portion are formed by laminating a plurality of iron pieces and bonding the first core portion and the second core portion to each other, to thereby reduce a manufacturing cost and simplify a manufacturing process.

Yet another object of the present invention is to provide a stator for use in a double rotor and a motor having the stator in which the stator core includes a laminated first core portion around which a first coil and a second coil are wound and laminated or compressively sintered second and third core portions that are bonded to both ends of the first core portion and whose areas are widely compared to that of the first core portion.

### Technical Solution

In order to achieve the above object, according to an aspect of the present invention, a stator includes: a plurality of stator cores; a bobbin wrapped around an outer circumferential surface of the stator core; and a coil wound around an outer circumferential surface of the bobbin, wherein each of the plurality of stator cores includes a first core portion that is formed by laminating a plurality of iron pieces, and around which a coil is wound, and a second core portion coupled to one end of the first core portion and disposed to face a magnet of a rotor and formed to be wider than an end surface area of the first core portion.

The first core portion may include a press-fit protrusion inserted into the second core portion formed at one end thereof, and a connecting portion for annularly connecting the stator cores formed at the other end thereof, wherein the connecting portion may include an engaging groove formed at one side of the other end of the first core portion and an engaging protrusion protrudingly formed at the other side of the other end of the first core portion and fitted into the engaging groove.

The second core portion may be formed by laminating a plurality of iron pieces, in which a press-fit groove into which the press-fit protrusion of the first core portion is press-fitted may be formed.

The second core portion may include: a first lamination portion laminated at the same height as the first core portion and formed with a press-fit groove; a second lamination portion laminated in a plurality of layers on an upper side of the first lamination portion; and a third lamination portion laminated in a plurality of layers on a lower side of the first lamination portion.

A fitting protrusion may be formed in the press-fit groove, and a fitting groove may be formed in the press-fit protrusion so that the fitting protrusion may be fitted into the fitting groove.

The second core portion may be formed integrally with the metal powder and may be formed with a press-fit groove to be press-fitted into the press-fit protrusion of the first core portion.

The second core portion may be formed of amorphous metal powder, soft magnetic powder, or alloy powder obtained by mixing amorphous metal powder and spherical soft magnetic powder.

The second core portion may be formed to have a larger width by an interval ‘A’ at left and right hands, respectively, than one end of the first core portion, and may be formed to have a larger width by an interval ‘B’ at upper and lower portions, respectively, than one end of the first core portion.

According to another aspect of the present invention, a stator includes: a stator core; a bobbin wrapped around an outer circumferential surface of the stator core; a first coil wound on one side of the stator core; and a second coil wound on the other side of the stator core, wherein the stator core includes: a first core portion formed by laminating a plurality of iron pieces and around which a first coil and a second coil are wound; a second core portion coupled to one end of the first core portion and disposed to face a magnet of an outer rotor, the second core portion having a larger area than one end of the first core portion; a third core portion coupled to the other end of the first core portion and facing a magnet of an inner rotor, the third core portion having a larger area than the other end of the first core portion.

The first core portion may include: a first press-fit protrusion press-fitted into the second core portion; a second press-fit protrusion into which the third core portion is press-fitted; a first winding portion around which the first coil is wound; a second winding portion around which the second coil is wound; and a connecting portion formed between the first winding portion and the second winding portion and annularly connecting the stator cores.

The second core portion may be formed with a first press-fit groove to be press-fitted into the first press-fit protrusion of the first core portion, and formed by laminating a plurality of iron pieces, and the third core portion may be formed with a second press-fit groove to be press-fitted into the second press-fit protrusion of the first core portion, and formed by laminating a plurality of iron pieces.

The second core portion and the third core portion may include: a first lamination portion that is laminated at the same height as the first core portion and formed with a press-fit groove; a second lamination portion laminated in a plurality of layers on an upper side of the first lamination portion; and a third lamination portion laminated in a plurality of layers on a lower side of the first lamination portion.

The second core portion and the third core portion may be formed integrally with metal powder, and may be respectively formed with the first press-fit groove and the second press-fit groove to be press-fitted into the first press-fit protrusion and the second press-fit protrusion of the first core portion.

### Advantageous Effects

As described above, a stator according to the present invention is formed by separately manufacturing a first core portion wound with a coil and a second core portion disposed opposite to a magnet, to then mutually bond the first core portion and the second core portion to each other, and enlarging an area of the second core portion compared to that of the first core portion, to thereby improve the efficiency of the motor.

In addition, a stator according to the present invention is formed to include a second core portion disposed opposite to a magnet that is formed by compression-molding amorphous metal powder, soft magnetic powder or a mixture of amorphous metal powder and soft magnetic powder, to thereby reduce a manufacturing cost and simplify a manufacturing process.

In addition, in a stator according to the present invention, a first core portion and a second core portion are formed by laminating a plurality of iron pieces and bonding the first core portion and the second core portion to each other, to thereby reduce a manufacturing cost and simplify a manufacturing process.

### BRIEF DESCRIPTION OF DRAWINGS

FIG. 1 is a cross-sectional view of a single rotor type motor according to an embodiment of the present invention.

FIG. 2 is a cross-sectional view of a stator according to a first embodiment of the present invention.

FIG. 3 is an exploded perspective view of a stator core according to the first embodiment of the present invention.

FIG. 4 is an exploded top view of a stator core according to the first embodiment of the present invention.

FIG. 5 is a plan view of a stator core according to the first embodiment of the present invention.

FIG. 6 is a plan view of a stator core according to the first embodiment of the present invention, in which a bobbin is coupled to the stator core.

FIG. 7 is an exploded perspective view of a stator core according to a second embodiment of the present invention.

FIG. 8 is an exploded perspective view of a stator core according to a third embodiment of the present invention.

FIG. 9 is an exploded perspective view of a stator core according to a forth embodiment of the present invention.

FIG. 10 is an exploded perspective view of a stator core according to a fifth embodiment of the present invention.

FIG. 11 is a cross-sectional view of a stator according to a sixth embodiment of the present invention.

FIG. 12 is an exploded perspective view of a stator core according to the sixth embodiment of the present invention.

FIG. 13 is a cross-sectional view of a double rotor type motor according to another embodiment of the present invention.

FIG. 14 is a cross-sectional view of a stator according to a seventh embodiment of the present invention.

FIG. 15 is an exploded plan view of a stator core according to the seventh embodiment of the present invention.

FIG. 16 is a plan view of a stator core according to the seventh embodiment of the present invention, in which a bobbin is coupled to the stator core.

FIG. 17 is a cross-sectional view of a stator according to an eighth embodiment of the present invention.

### BEST MODE

Hereinafter, embodiments of the present invention will be described in detail with reference to the accompanying drawings. The sizes and shapes of the components shown in the drawings may be exaggerated for clarity and convenience. In addition, terms defined in consideration of the configuration and operation of the present invention may vary depending on the intention or custom of the user, the operator, and the like. Definitions of these terms should be based on the content of this specification.

Referring to FIG. 1, a single rotor type motor according to an embodiment of the present invention includes a stator 10 and a rotor 20 disposed at a predetermined gap on an outer circumferential surface of the stator 10 and connected to a rotating shaft 40.

The rotor 20 includes a magnet 22 disposed at a predetermined gap on an outer circumferential surface of the stator 10, a back yoke 24 disposed on a back surface of the magnet 22, and a rotor support 26 fixed to the magnet 22 and the back yoke 24 and connected to the rotary shaft 60.

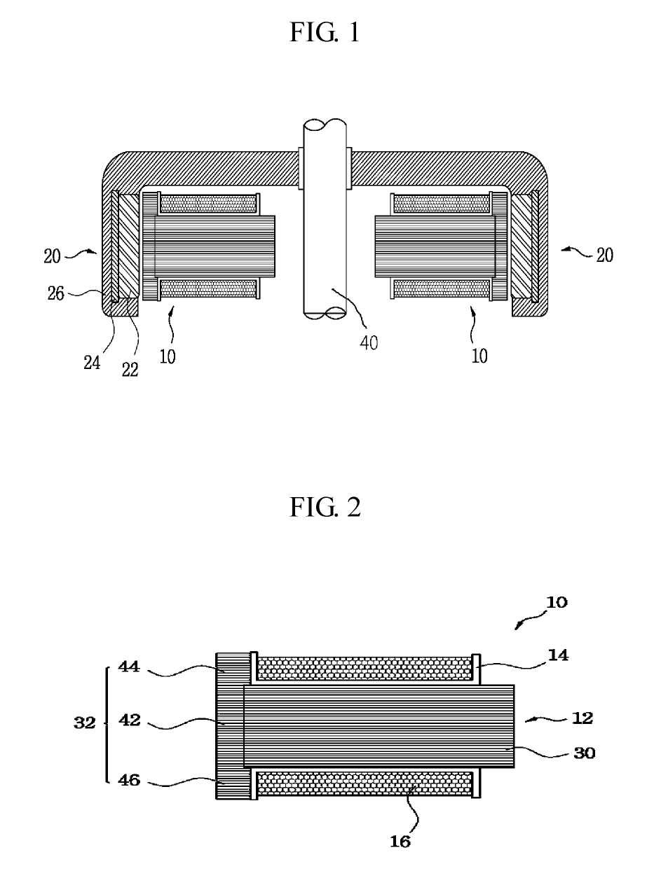

As shown in FIG. 2, the stator 10 includes a plurality of stator cores 12 arranged in an annular shape, a bobbin 14 made of an insulating material wrapped around an outer circumferential surface of the stator core 12, and a coil 16 wound on an outer circumferential surface of the bobbin 14.

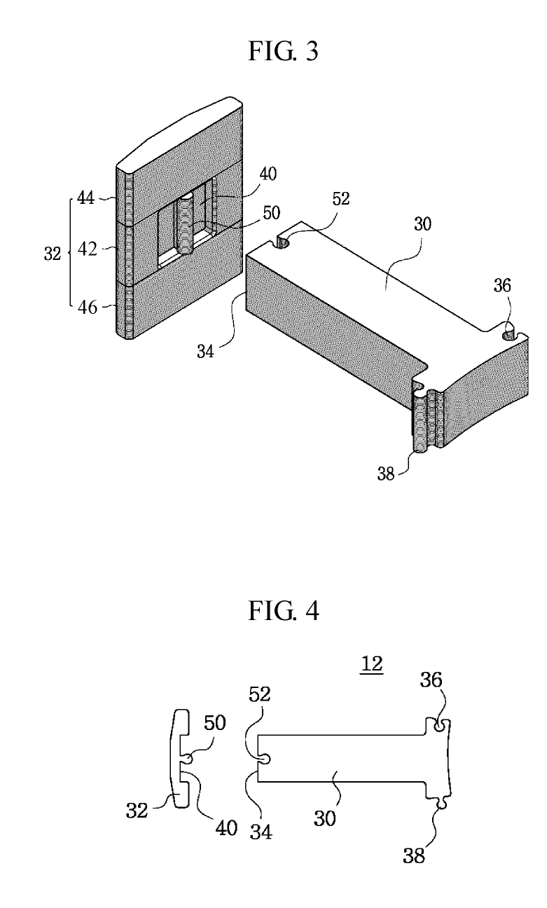

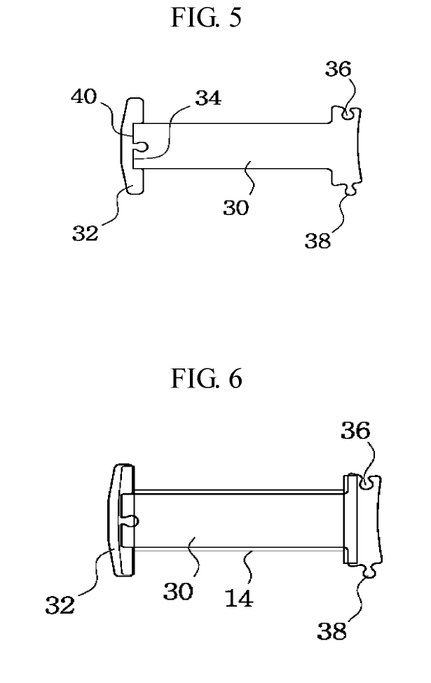

As shown in FIGS. 3 to 6, the stator core 12 according to a first embodiment includes a first core portion 30 that is a split core type and interconnected to form an annular shape, wherein the first core portion 30 is formed by laminating a plurality of iron pieces and around which a coil is wound, and a second core portion 32 is formed by laminating a plurality of iron pieces, coupled to the first core portion 30 and disposed to face the magnet 22.

The first core portion 30 is formed by laminating a plurality of iron pieces. At one end of the first core portion 30 is formed a press-fit protrusion 34 to be inserted into the second core portion 32. At the other end thereof are formed connecting portions 36 and 38 that connect between the stator cores in an annular form.

The connecting portions 36 and 38 connect directly between the stator cores 12 arranged in a radial direction so that the split type stator cores 12 can be mutually energized to form a magnetic circuit.

The connecting portions 36 and 38 include an engaging groove 36 formed at one side of the other end of the first core portion 30 and an engaging protrusion 38 protrudingly formed at the other side of the other end of the first core portion 30 and fitted into the engaging groove 36.

In addition to such a connecting structure of the connecting portions 36 and 38, the connecting portions have a structure that pinholes are formed at both end portions of the first core portion, and a pin member is fitted into and coupled with the pinholes of two stator cores at a state where the stator cores contact each other, to thereby employ a structure of connecting between the stator cores. Alternatively, the connecting portions may employ a method of caulking the stator cores by using a caulking member in a state where the stator cores contact each other.

The second core portion 32 is formed by laminating a plurality of iron pieces like the first core portion 30 in which is formed with a press-fit groove 40 into which the press-fit protrusion 34 of the first core portion 30 is press-fitted.

The second core portion 32 may include: a first lamination portion 42 that is laminated at the same height as the first core portion 30 and formed with a press-fit groove 40; a second lamination portion 44 laminated in a plurality of layers on an upper side of the first lamination portion 42 and having no press-fit groove; and a third lamination portion 46 laminated in a plurality of layers on a lower side of the first lamination portion 42 and having no press-fit groove.

As described above, the second core portion 32 according to the first embodiment is formed to have a larger area than an area of one end of the first core portion 30, thereby improving the efficiency of a motor employing the stator according to the present invention. That is, the left and right side surfaces of the second core portion 32 are formed wider than the left and right side surfaces of one end of the first core portion 30, and the upper and lower portions of the second core portion 32 are formed to be wider than the upper and lower sides of one end of the first core portion 30 by the second lamination portion 44 and the third lamination portion 46.

In this case, a circular fitting protrusion 50 is formed in the press-fit groove 40, and a circular fitting groove 52 is formed in the press-fit protrusion 34 so that the fitting protrusion 50 is fitted into the fitting groove 52, thereby increasing a bonding force between the first core portion 30 and the second core portion 32.

As described above, the second core portion 32 is formed so as to be laminated as much as the second lamination portion 44 and the third lamination portion 46 with respect to the first core portion 30 in the same direction as the axial direction of the rotating shaft 60, thereby increasing an area of the surface facing the magnet 22 and minimizing the leakage magnetic flux, thus improving the efficiency of the motor.

A process of manufacturing the above-configured stator according to the first embodiment will be described below.

First, the first core portion 30 and the second core portion 32 are separately manufactured by cutting an iron plate.

That is, the first core portion 30 integrally includes the press-fit protrusion 34, the engaging protrusion 38, and the engaging groove 36, and the second core portion 32 is integrally formed by respectively fabricating the first lamination portion 42 having the press-fit groove 40, and the second lamination portion 44 and the third lamination portion 46 each having no press-fit groove.

The first core portion 30 is formed by laminating a plurality of iron pieces and the second core portion 32 is formed by sequentially laminating the third laminate portion 46, the first laminate portion 42, and the second laminate portion 44.

The press-fit protrusion 34 of the first core portion 30 is press-fitted into the press-fit groove 40 of the second core portion 32 to join the first core portion 30 and the second core portion 32.

The bobbin 14 is formed by insert-molding a resin of an insulating material onto the outer surfaces of the first core portion 30 and the second core portion 32.

Here, the method of forming the bobbin 14 may be a method of forming the bobbin by a single insert-molding after arranging the stator cores in an annular shape in addition to the method of forming the bobbin in each of the split cores.

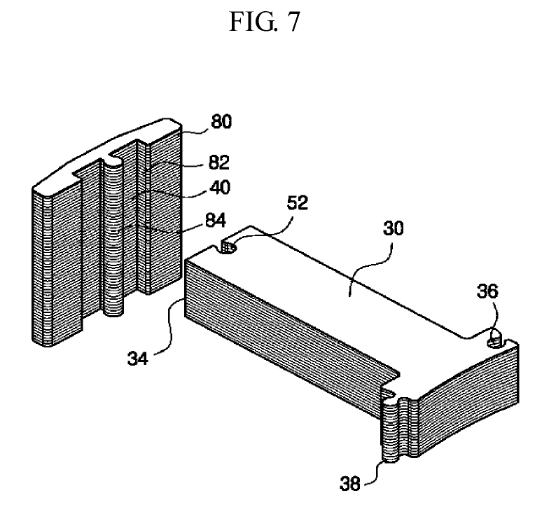

As shown in FIG. 7, the stator core according to the second embodiment of the present invention is a split core type and interconnected to form an annular shape, and includes a first core portion 30 that is formed by laminating a plurality of iron pieces and around which a coil is wound, and a second core portion 80 that is formed by laminating a plurality of iron pieces, coupled to the first core portion 30, and disposed to face the magnet 22.

The first core portion 30 has the same structure as the first core portion 30 described in the first embodiment.

The second core portion 80 is formed by laminating a plurality of iron pieces similarly to the first core portion 30. Areas of the upper and lower sides as well as the left and right sides of the second core portion 80 are formed so as to be wider than the cross-sectional area of the first core portion 30.

At the center of the second core portion 80 is formed a press-fit groove 82 in which the press-fit protrusion 34 of the first core portion 30 is press-fitted in the vertical direction. As described above, the second core portion 80 is formed to have the press-fit groove 82 that is formed by putting one upon another press-fit groove identically formed in each of the iron pieces constituting the second core portion, to thereby simplify assembly.

In addition, a circular fitting protrusion 84 is formed in the center of the press-fit groove 40, and a circular fitting groove 52 is formed in the press-fit protrusion 34 so that the fitting protrusion 84 is fitted into the fitting groove 52, thereby increasing a bonding force between the first core portion 30 and the second core portion 80.

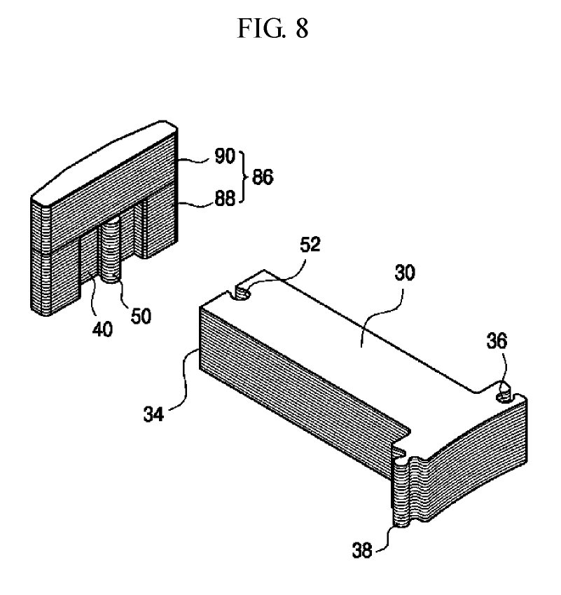

As shown in FIG. 8, a stator core according to the third embodiment of the present invention has a second core portion 86 of a different shape from that of the first embodiment.

The second core portion 86 according to the third embodiment includes a first lamination portion 88 laminated at the same height as the first core portion 30 and formed with a press-fit groove 40, and a second lamination portion 90 laminated on an upper side or a lower side of the first lamination portion 88 in a plurality of layers and having a shape having no press-fit groove.

That is, the stator core described in the first embodiment has a structure formed in a “T” shape as a whole in the case that the first core portion 30 and the second core portion 32 are mutually coupled, and the stator core described in the third embodiment has a structure integrally formed in an “L” shape as a whole in the case that the first core portion 30 and the second core portion 86 are mutually coupled.

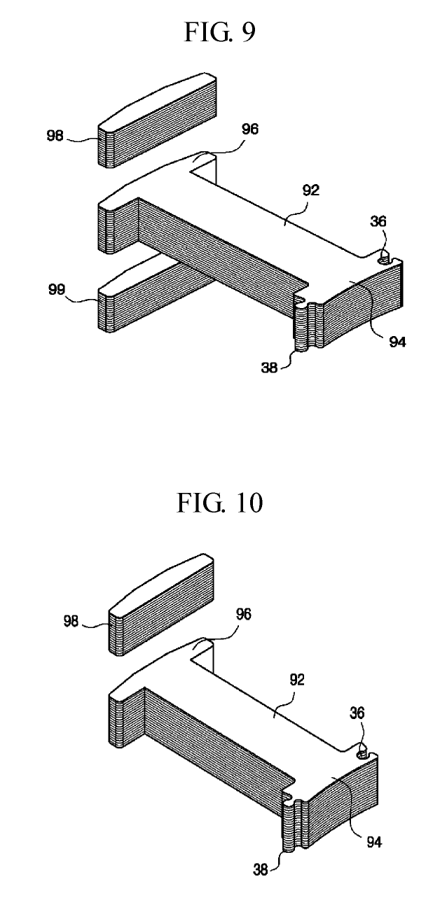

As shown in FIG. 9, the stator core according to the fourth embodiment of the present invention includes a first core portion 92 having a tooth portion 96 formed on one side thereof and a connecting portion 94 formed on the other side thereof, and second core portions 98 and 99 laminated on both an upper side and a lower side of the tooth portion 96, respectively.

Here, the first core portion 92 is formed, at one end thereof, with the tooth portion 96 having an enlarged area in the lateral direction of the first core portion, and is formed, at the other end thereof, with the connecting portion 94 so that the stator cores are interconnected to form an annular shape.

The second core portions 98 and 99 are formed in the same shape as that of the tooth portion 96, are formed by laminating a plurality of iron pieces, and have a first lamination portion 98 fixed to the upper surface of the tooth portion 96, and a second lamination portion 99 which is formed in the same shape as that of the first lamination portion 98 and is fixed to the lower surface of the tooth portion 96.

Here, it is preferable that the first lamination portion 98 and the second lamination portion 99 are fixed to the upper surface and the lower surface of the tooth portion 96, respectively, by bonding.

In the stator core according to the fourth embodiment, the first core portion is formed in the same shape as that of the conventional stator core and the first and second lamination portions are fixed on the upper and lower surfaces of the tooth portion, respectively, to complete assembly, thereby enabling an easy and simple assembly.

As shown in FIG. 10, the stator core according to the fifth embodiment of the present invention has the same configuration as that of the stator core of the fourth embodiment, except that a lamination portion 98 is fixed on only one of the upper surface and the lower surface of the tooth portion 96.

That is, the lamination portion 98 formed by laminating a plurality of iron pieces on either the upper surface or the lower surface of the tooth portion 96 and having the same shape as the tooth portion 96 is fixed in the stator core according to the fifth embodiment.

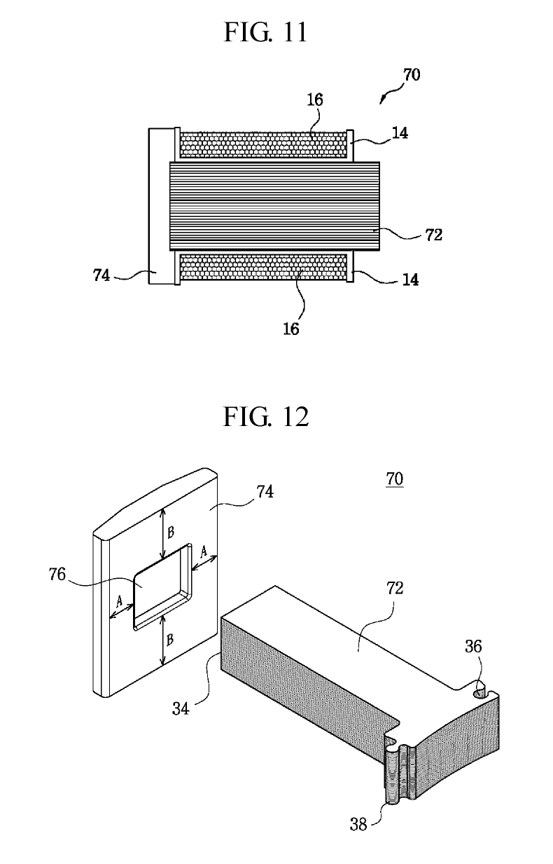

As shown in FIGS. 11 and 12, the stator core 70 according to the sixth embodiment includes a first core portion 72 formed by laminating a plurality of iron pieces and around which a coil 16 is wound, and a second core portion 74 integrally formed by a metal mold by compression-molding amorphous metal powder, coupled to the first core portion 72 and disposed to face the magnet 22.

The first core portion 72 is formed in the same shape as that of the first core portion 30 described in the first embodiment.

The second core portion 74 may be formed by mixing amorphous metal powder and a binder, or may be formed by mixing amorphous metal powder, crystalline metal powder having excellent soft magnetic properties, and a binder in a predetermined ratio. In this case, when the metal powder is mixed at a predetermined ratio as compared with the case where 100% of the amorphous metal powder is used, the difficulty of high-pressure sintering can be solved and the permeability can be increased.

The second core portion 74 may be manufactured by compression-molding with only the soft magnetic powder. The second core portion 74 may be manufactured by extrusion-molding in addition to compression-molding.

The second core portion 74 is formed with a press-fit groove 76 into which the press-fit protrusion 34 of the first core portion 72 is press-fitted, and is formed to have wider areas in the upper and lower sides as well as the left and right sides of the second core portion 74, than those of the first core portion 72.

That is, the left and right sides of the second core portion 74 are formed to be wider by an interval ‘A’ than the left and right sides of the one end of the first core portion, and the upper and lower sides of the second core portion 74 are formed to be wider by an interval ‘B’ than the upper and lower sides of the one end of the first core portion.

As described above, in the stator core 70 according to the sixth embodiment, the first core portion 72 around which the coil is wound is formed by laminating a plurality of iron pieces, and the second core portion 74 disposed to face the magnet 22 is formed to have wider areas in the upper and lower sides as well as the left and right sides of the second core portion 74, than those of the first core portion 72. In addition, the second core portion 74 is fabricated by compression-molding the amorphous metal powder, thereby improving the motor performance while reducing the manufacturing cost.

A process of manufacturing the above-configured stator according to the sixth embodiment will be described below.

First, the first core portion 72 is manufactured by cutting the iron plate.

Then, the second core portion 74 is produced by compression-molding the amorphous metal powder.

The second core portion 74 can be formed by mixing the amorphous metal powder and the binder, by mixing the amorphous metal powder and the crystalline metal powder having excellent soft magnetic properties and the binder at a predetermined ratio, or by mixing the crystalline metal powder having excellent soft magnetic properties and the binder.

The press-fit protrusion 34 of the first core portion 72 is press-fitted into the press-fit groove 76 of the second core portion 74 to join the first core portion 72 and the second core portion 74.

The bobbin 14 is formed by insert-molding a resin of an insulating material onto the outer surfaces of the first core portion 72 and the second core portion 74.

Here, the method of forming the bobbin 14 may be a method of forming the bobbin by a single insert-molding after arranging the stator cores in an annular shape in addition to the method of forming the bobbin in each of the split cores.

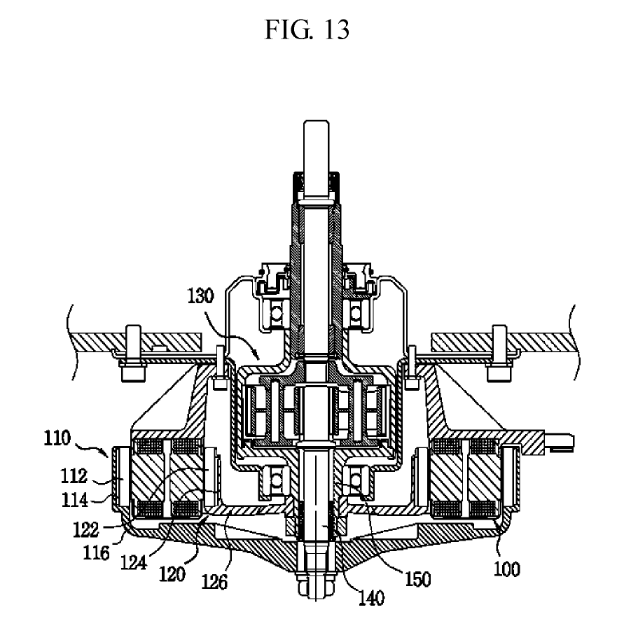

FIG. 13 is a cross-sectional view of a double rotor type motor according to another embodiment of the present invention.

The double rotor type motor includes a stator 100, an outer rotor 110 disposed with an air gap on the outer surface of the stator 100, an inner rotor 120 disposed with an air gap on the inner surface of the stator 100, and a planetary gear set 130 connected to either one of the inner rotor 120 and the outer rotor 110 for reducing the rotational speed and outputting the reduced rotational speed.

The outer rotor 110 includes a first magnet 112 disposed on the outer surface of the stator 100 with a predetermined gap therebetween, a first back yoke 114 disposed on the rear surface of the first magnet 112, and an outer rotor support 116 integrally formed with the first magnet 112 and the first back yoke 114 by the insert-molding.

Here, the outer rotor support 116 is integrally formed with the first magnet 112 and the first back yoke 114 by molding with a BMC (Bulk Molding Compound) molding material such as a thermosetting resin, for example, polyester.

The inner rotor 120 includes a second magnet 122 disposed with an air gap on the inner surface of the stator 100, a second back yoke 124 disposed on the rear surface of the second magnet 122, and an inner rotor support 126 integrally formed with the second magnet 122 and the second back yoke 124 by the insert-molding.

Here, the inner rotor support 126 is integrally formed with the second magnet 122 and the second back yoke 124 by molding with a BMC (Bulk Molding Compound) molding material such as a thermosetting resin, for example, polyester.

The outer rotor support 126 is connected to an inner shaft 140 and the inner rotor support 126 is connected to an outer shaft 150.

The planetary gear set 130 is provided in the inner shaft 140 to decrease the rotation speed of the inner shaft 140 to thus increase the torque.

The planetary gear set 130 includes a sun gear, a planetary gear and a carrier, and a ring gear serving as a housing. When a rotation input is applied to the sun gear, a reduced output is output from the carrier when the ring gear is fixed. When the rotation input of an identical direction and an identical RPM is applied to the sun gear and the ring gear, the entire planetary gear set 130 rotates without deceleration.

When the double rotor type motor according to the present invention and a driving apparatus with which the planetary gear set 130 is combined are applied to a washing machine, the outer shaft 150 is connected to a washing tub, and the inner shaft 140 is connected to a pulsator.

When the outer rotor 110 is driven and a rotational force is applied to the planetary gear set 130 via the lower inner shaft 140 and the inner rotor 120 is stopped by an electromagnetic brake, the decelerated output via the sun gear, the planetary gear, and the carrier of the planetary gear set 130 is transferred to the pulsator through the upper inner shaft 140. The output of the outer rotor 110 can be used in the washing and rinsing cycles of a washing machine as the output of the outer rotor 110 whose rotational speed is reduced and whose torque is increased while passing through the planetary gear set 130 is applied to the pulsator.

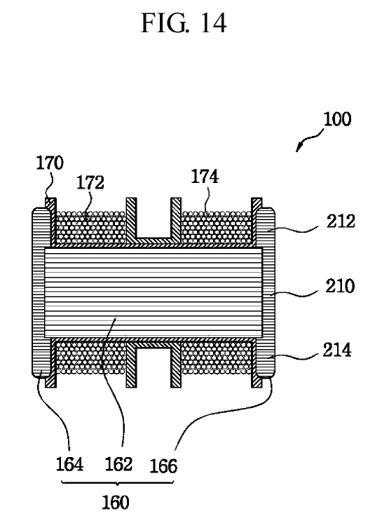

As shown in FIG. 14, the stator 100 includes a stator core 160, a bobbin 170 wrapped around the outer circumferential surface of the stator core 160, a first coil 172 wound on one side of the stator core 160, and a second coil 174 wound on the other side of the stator core 160.

The stator 100 serves as a double stator that selectively drives an outer rotor 110 and an inner rotor 120 according to first and second drive signals independently applied to the first coil 172 and the second coil 174 from a motor driver (not shown).

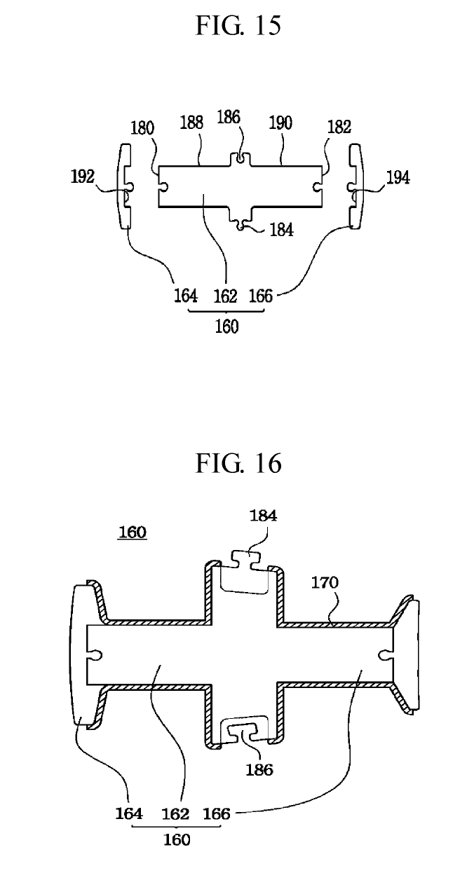

As shown in FIGS. 15 and 16, a stator core 160 according to the seventh embodiment includes: a first core portion 162 that is in the form of a split core and interconnected to form an annular shape, and that is formed by laminating a plurality of iron pieces, in which first and second coils are wound around the first core portion 162; a second core portion 164 that is formed by laminating a plurality of iron pieces, that is coupled to one end of the first core portion 30, and that is disposed to face a first magnet 112 of the outer rotor 110; and a third core portion 166 coupled to the other end of the first core portion 162 and disposed to face a second magnet 122 of the inner rotor 120.

The first core portion 162 is formed by laminating a plurality of iron pieces in which a first press-fit protrusion 180 press-fitted into the second core portion 164 is formed at one end of the first core portion 162, and a second press-fit protrusion 182 press-fitted into the third core portion 166 is formed at the other end of the first core portion 162. At the center of the first core portion 162 are formed connecting portions 184 and 186 for annularly connecting between the stator cores.

The connecting portions 184 and 186 connect directly between the stator cores 160 arranged in a radial direction so that the split type stator cores 160 can be mutually energized to form a magnetic circuit.

The connecting portions 184 and 186 include an engaging groove 186 formed in one side of the center of the first core portion 162 and an engaging protrusion 184 that is formed to protrude from the other side of the center of the first core portion 162 and is fitted into the engaging groove 186.

In addition to such a connection structure of the connecting portions 184 and 186, the connecting portions have a structure that pinholes are formed at both end portions of the first core portion, and a pin member is fitted into and coupled with the pinholes of two stator cores at a state where the stator cores contact each other, to thereby employ a structure of connecting between the stator cores. Alternatively, the connecting portions may employ a method of caulking the stator cores by using a caulking member in a state where the stator cores contact each other.

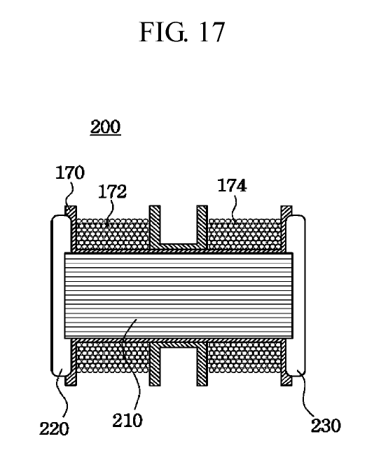

The first core portion 162 has a first coil portion 188 formed on one side of the connecting portions 184 and 186 and around which a first coil 172 (for example, see FIG. 17) is wound, and a second coil portion 190 formed on the other side of the connecting portions 184 and 186, and around which a second coil 174 (for example, see FIG. 17) is wound.

The second core portion 164 is formed with a first press-fit groove 192 to be press-fitted into the first press-fit protrusion 180 of the first core portion 162 and formed by laminating a plurality of iron pieces.

The third core portion 166 is formed with a second press-fit groove 194 to be press-fitted into the second press-fit protrusion 182 of the first core portion 162 and formed by laminating a plurality of iron pieces.

In addition, a circular fitting protrusion 50 is formed in the first press-fit groove 192 and the second press-fit groove 194, respectively, and a circular fitting groove 52 is formed in the first press-fit protrusion 180 and the second press-fit protrusion 182, respectively, so that the fitting protrusions 50 are fitted into the fitting grooves 52, thereby increasing a bonding force between the first core portion 162 and the second core portion 164 and between the first core portion 162 and the third core portion 166, respectively.

The second core portion 164 and the third core portion 166 may include: a first lamination portion 210 that is laminated at the same height as the first core portion 162 and formed with the first press-fit groove 192 and the second press-fit groove 194; a second lamination portion 212 laminated in a plurality of layers on an upper side of the first lamination portion 210; and a third lamination portion 214 laminated in a plurality of layers on a lower side of the first lamination portion 210.

Here, the second or third lamination portion may have a structure in which the second or third lamination portion is laminated on only one of the upper surface and the lower surface of the first lamination portion 210. That is, the second or third lamination portion may have a structure in which the second laminate portion 212 is laminated only on the upper surface of the first lamination portion 210, or the third lamination portion 214 is laminated only on the lower surface of the first lamination portion 210.

In addition, the press-fit groove formed in the first lamination portion may be formed in the second lamination portion and the third lamination portion, respectively. That is, the first lamination portion, the second lamination portion, and the third lamination portion may be formed in an identical shape in which the press-fit grooves are respectively formed.

Further, like the stator core described in the fourth embodiment, the stator core described in the seventh embodiment is configured so that the tooth portions may be formed at both ends of the first core portion, respectively, and a lamination portion formed in the same shape as each of the tooth portions, and formed by laminating a plurality of iron pieces may be formed on at least one of the upper surface and the lower surface of each of the tooth portions.

As shown in FIG. 17, the stator core 200 according to the eighth embodiment includes: a first core portion 210 formed by laminating a plurality of iron pieces and wound with a first coil 172 and a second coil 174; a second core portion 220 formed by compression-molding an amorphous metal powder and formed integrally in a mold, in which the second core portion 220 is coupled to one end of the first core portion 210 and disposed to face the first magnet 112; and a third core portion 230 formed by compression-molding an amorphous metal powder and formed integrally in a mold, in which the third core portion 230 is coupled to the other end of the first core part 210 and disposed to face the second magnet 122.

The first core portion 210 is formed in the same shape as that of the first core portion 162 described in the third embodiment.

The second core portion 220 and the third core portion 230 may be formed by mixing amorphous metal powder and a binder, or may be formed by mixing amorphous metal powder, crystalline metal powder having excellent soft magnetic properties, and a binder in a predetermined ratio. In this case, when the metal powder is mixed at a predetermined ratio as compared with the case where 100% of the amorphous metal powder is used, the difficulty of high-pressure sintering can be solved and the permeability can be increased.

The second core portion 220 and the third core portion 230 have the same shape as the second core portion 70 described in the sixth embodiment shown in FIG. 11, and the left and right sides of each of the second core portion 220 and the third core portion 230 are formed to be wider by an interval ‘A’ than the left and right sides of the one end of the first core portion 210, and the upper and lower sides of each of the second core portion 220 and the third core portion 230 are formed to be wider by an interval ‘B’ than the upper and lower sides of the one end of the first core portion 210.

The stator 200 serves as a double stator that selectively drives the outer rotor 110 and the inner rotor 120 according to the first and second driving signals that are independently applied from a motor driver (not shown) to the first coil 172 and the second coil 174 in the same manner as the stator core 100 according to the seventh embodiment.

The stator 200 serving as a double stator may be applied to the double rotor type motor shown in FIG. 13 and used as a washing machine driving device.

In the above description of the embodiments, the stator 100 or 200 is applied to a structure of the double rotor type motor shown in FIG. 13, that is, in which the outer rotor is connected to the inner shaft and the inner rotor is connected to the outer shaft, but it is also possible that the stator 100 or 200 is applied to a structure in which the outer rotor is connected to the outer shaft and the inner rotor is connected to the inner shaft.

While the present invention has been particularly shown and described with reference to exemplary embodiments thereof, by way of illustration and example only, it is clearly understood that the present invention is not to be construed as limiting the present invention, and various changes and modifications may be made by those skilled in the art within the protective scope of the invention without departing off the spirit of the present invention.

### INDUSTRIAL APPLICABILITY

The present invention can embody a stator for a single rotor or a double rotor by using a stator core in which lamination type or compression-sintering type second and third core portions each having a larger area than one end of a first core portion are provided on one side or both sides of a lamination type first core portion in which a coil is wound, and can be applied to a washing machine driving apparatus.

What is claimed is:

1. A stator comprising:
a plurality of stator cores;
a bobbin wrapped around an outer circumferential surface of each of the stator cores; and
a coil wound around an outer circumferential surface of the bobbin,
wherein each of the plurality of stator cores includes a first core portion that is formed by laminating a plurality of iron pieces, and around which the coil is wound, and a second core portion coupled to one end of the first core portion and disposed to face a magnet of a rotor and formed to be wider than an end surface area of the first core portion,
wherein the first core portion comprises a press-fit protrusion formed at one end thereof and inserted into the second core portion, and a connecting portion formed at the other end thereof for annularly connecting the stator cores, wherein the connecting portion includes an engaging groove formed at one side of the other end of the first core portion and an engaging protrusion protrudingly formed at the other side of the other end of the first core portion and fitted into an engaging groove of an adjacent connecting portion, and
wherein the second core portion is formed of a metal powder and forms a single integral piece, in which a press-fit groove, into which the press-fit protrusion of the first core portion is press-fitted, is formed.

2. The stator of claim 1, wherein the metal powder includes: an amorphous metal powder, a soft magnetic powder, or an alloy powder in which an amorphous metal powder and a spherical soft magnetic powder are mixed.

3. The stator of claim 1, wherein left and right sides of the second core portion are formed to be wider by an interval ‘A’ than the end surface area of the first core portion, and upper and lower sides of the second core portion are formed to be wider by an interval ‘B’ than the end surface area of the first core portion.
